(19) United States
(12) Patent Application Publication
(10) Pub. No.: US 2018/0110025 A1
(43) Pub. Date: Apr. 19, 2018

(54) AGILE MEASUREMENT STRATEGY FOR TERRESTRIAL POSITIONING

(71) Applicant: QUALCOMM Incorporated, San Diego, CA (US)

(72) Inventor: Jignesh Doshi, Carlsbad, CA (US)

(21) Appl. No.: 15/459,540

(22) Filed: Mar. 15, 2017

Related U.S. Application Data
(60) Provisional application No. 62/408,212, filed on Oct. 14, 2016.

(51) Int. Cl. H04W 64/00; H04L 29/06; H04W 48/16

(52) U.S. Cl. CPC H04W 64/00; H04W 48/16; H04L 69/28

(57) ABSTRACT

Techniques provided herein enable a mobile device to maintain a terrestrial transceiver history indicating the success of previous measurements attempts with terrestrial transceivers for location determination. This history can be used to prioritize terrestrial transceivers with which future measurement attempts are to be made.

### RELATED APPLICATIONS

This application claims the benefit of U.S. Provisional Application No. 62/408,212, filed Oct. 14, 2016, entitled “Agile Measurement Strategy For Terrestrial Positioning,” which is assigned to the assignee hereof, and incorporated herein in its entirety by reference.

### BACKGROUND

### 1. Field

The subject matter disclosed herein relates to mobile device positioning. In particular, systems in which terrestrial transceivers (cell phone towers, Wi-Fi access points, Bluetooth beacons, and/or the like) are used to calculate the position of a mobile device, in a process herein referred to as “terrestrial positioning.” Even so, the techniques provided herein may be, in some embodiments, used in other applications.

### 2. Information

Terrestrial positioning of a mobile device (e.g., a mobile phone, tablet, personal media player, wearable device, in-vehicle system, etc.) can enable the mobile device to take distance measurements from terrestrial transceivers (access points, base stations, etc.), and use known locations of those terrestrial transceivers to calculate the location (or provide a “position fix” or “location fix”) of the mobile device.

As part of this process, the mobile device can receive data from a location server that includes the identities and locations of nearby terrestrial transceivers with which the mobile device may attempt to take distance measurements. But the process of conducting measurements can be inefficient. According to some traditional techniques, a mobile device may continue to attempt to take measurements with certain terrestrial transceivers no matter how many previous failed attempts the mobile device may have made. These inefficiencies can delay a position fix (including time to first fix, or TTFF) and consume power and processing resources, causing the user experience to suffer.

### SUMMARY

Techniques provided herein enable a mobile device to maintain a terrestrial transceiver history indicating the success of previous measurements attempts with terrestrial transceivers for location determination. This history can be used to prioritize terrestrial transceivers with which future measurement attempts are to be made.

An example method of taking measurements for position location by a mobile device, according to the disclosure, comprises obtaining, at the mobile device, information indicative of an estimated position of the mobile device, obtaining, at the mobile device, an identity of each terrestrial transceiver of a first plurality of terrestrial transceivers, obtaining, at the mobile device, a prioritization of one or more terrestrial transceivers from the first plurality of terrestrial transceivers based on the estimated position of the mobile device, and attempting, by the mobile device, to measure signals received from the one or more terrestrial transceivers in an order based on the prioritization.

The method may include one or more of the following features. Obtaining the prioritization may comprise attempting, in a prior attempt, to measure signals received from the one or more terrestrial transceivers. The method may further comprise storing, for each terrestrial transceiver of the one or more terrestrial transceivers, information associating a prior estimated location of the mobile device with an indication of whether the prior attempt to measure signals received from the one or more terrestrial transceivers was successful. The method may further comprise computing a position of the mobile device based on measurements of signals received from the one or more terrestrial transceivers. The computed position of the mobile device may be more accurate than the estimated position of the mobile device. The method may further comprise, subsequent to obtaining the identity of each terrestrial transceiver of the first plurality of terrestrial transceivers, obtaining an identity of each terrestrial transceiver of a second plurality of terrestrial transceivers, wherein the second plurality of terrestrial transceivers includes the one or more terrestrial transceivers. The identity of each terrestrial transceiver of the first plurality of terrestrial transceivers and the identity of each terrestrial transceiver of the second plurality of terrestrial transceivers may be obtained from different sources. Obtaining the an identity of each terrestrial transceiver of the first plurality of terrestrial transceivers comprises receiving the identity of each terrestrial transceiver of the first plurality of terrestrial transceivers from a location server. The method may further comprise, for the one or more terrestrial transceivers, purging stored information indicative of whether the attempt to measure signals received from the one or more terrestrial transceivers was successful. The purging may occur after a threshold period of time has elapsed since the attempt to measure signals received from the one or more terrestrial transceivers. The purging may occur after receiving, from at least one location server, assistance data a threshold number of times. The method may further comprise obtaining an identity of each terrestrial transceiver of a second plurality of terrestrial transceivers detected by the mobile device and sending, to a location server, an identity of at least one terrestrial transceiver of the second plurality of terrestrial transceivers not included in the first plurality of terrestrial transceivers.

An example mobile device can comprise a wireless communication interface, a memory, and a processing unit communicatively coupled with the wireless communication interface and the memory and configured to cause the mobile device to obtain information indicative of an estimated position of the mobile device, obtain an identity of each terrestrial transceiver of a first plurality of terrestrial transceivers, obtain a prioritization of one or more terrestrial transceivers from the first plurality of terrestrial transceivers based on the estimated position of the mobile device, and attempt to measure signals received from the one or more terrestrial transceivers in an order based on the prioritization.

The mobile device can comprise one or more of the following features. The processing unit may be configured to cause the mobile device to obtain the prioritization by attempting, in a prior attempt, to measure signals received from the one or more terrestrial transceivers. The processing unit may be configured to cause the mobile device to store, in the memory, for each terrestrial transceiver of the one or more terrestrial transceivers, information associating a prior estimated location of the mobile device with an indication of whether the prior attempt to measure signals received from the one or more terrestrial transceivers was successful. The processing unit may be configured to cause the mobile device to compute a position of the mobile device based on measurements of signals received from the one or more terrestrial transceivers. The processing unit may be configured to cause the mobile device to, subsequent to obtaining the identity of each terrestrial transceiver of the first plurality of terrestrial transceivers, obtain an identity of each terrestrial transceiver of a second plurality of terrestrial transceivers, wherein the second plurality of terrestrial transceivers includes the one or more terrestrial transceivers. The processing unit may be configured to cause the mobile device to obtain the identity of each terrestrial transceiver of the first plurality of terrestrial transceivers and the identity of each terrestrial transceiver of the second plurality of terrestrial transceivers from different sources.

An example apparatus, according to the disclosure, comprises means for obtaining information indicative of an estimated position of the apparatus, means for obtaining an identity of each terrestrial transceiver of a first plurality of terrestrial transceivers, means for obtaining a prioritization of one or more terrestrial transceivers from the first plurality of terrestrial transceivers based on the estimated position of the apparatus, and means for attempting to measure signals received from the one or more terrestrial transceivers in an order based on the prioritization. The means for obtaining the prioritization may include means for attempting, in a prior attempt, to measure signals received from the one or more terrestrial transceivers.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a simplified illustration of an embodiment of a positioning system used to determine a location of a mobile device.

FIG. 2 is a simplified overhead illustration of a geographic area, according to an embodiment.

FIGS. 3-5 are Venn diagrams that illustrate the relationship between assistance data, data received by a data connectivity searcher, and the various groups of terrestrial transceivers described herein, according to an embodiment.

FIG. 6 is a flow diagram of a method of taking measurements for position location by a mobile device, according to an embodiment

FIG. 7 is an embodiment of a mobile device.

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

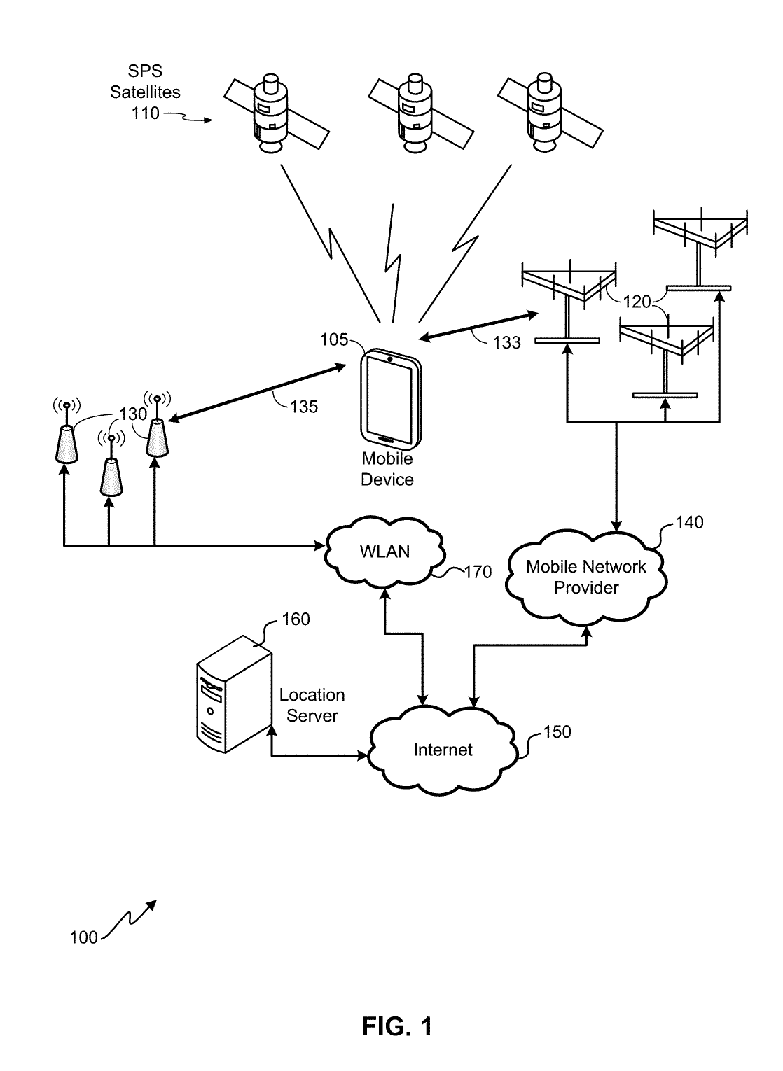

FIG. 1 is a simplified illustration of an embodiment of a positioning system 100 used to determine a location of a mobile device 105, which may implement the techniques described herein for terrestrial positioning. The techniques described herein may therefore be implemented by one or more components of the positioning system 100. The positioning system can include a mobile device 105, satellite positioning service (SPS) satellites 110, base transceiver stations 120, mobile network provider 140, access points (APs) 130, location server 160, wireless local area network (WLAN) 170, and the Internet 150. It can be noted that the positioning system 100 includes both non-terrestrial positioning (e.g., via SPS satellites 110), as well as positioning via terrestrial transceivers. Here, terrestrial transceivers can include APs 130 and/or base transceiver stations 120, which are communicatively coupled with the location server 160. It can further be noted that a plurality of location servers may be utilized, and different location servers may correspond with different types of terrestrial transceivers (which may be maintained by different entities). Thus, in some embodiments, there may be one location server for APs 130 and another location server for base transceiver stations 120. Additionally or alternatively, different mobile network providers and/or other networks may maintain different location servers.

It should be noted that FIG. 1 provides only a generalized illustration of various components, any or all of which may be utilized as appropriate, and each of which may be duplicated depending on the application. Specifically, although only one mobile device 105 is illustrated, it will be understood that many mobile devices (e.g., hundreds, thousands, millions, etc.) may be utilized in the positioning system 100. Similarly, the positioning system 100 may include many base transceiver stations 120 and/or APs 130. (That said, some embodiments may have fewer base transceiver stations 120 and/or APs 130 than shown). The illustrated connections that connect the various components in the positioning system 100 comprise data connections which may include additional (intermediary) components, direct or indirect connections, and/or additional networks. Furthermore, components may be rearranged, combined, separated, substituted, and/or omitted, depending on desired functionality. A person of ordinary skill in the art will recognize many modifications to the components illustrated.

The base transceiver stations 120 are communicatively coupled to the mobile network provider 140 (such as a cell phone network) which may be communicatively coupled with the Internet 150. In some embodiments, the base transceiver stations 120 may employ any of a variety of wireless technologies. The location server(s) 160 can also be communicatively coupled with the Internet 150. Thus, the mobile device 105 can communicate with the location server(s) 160, for example, by accessing the Internet 150 via the base transceiver stations 120 using a first communication link 133. Additionally or alternatively, because APs 130 and WLAN 170 also may be communicatively coupled with the Internet 150, the mobile device 105 may communicate with the location server(s) 160 using a second communication link 135.

Depending on desired functionality, a location of the mobile device 105 can be determined in any of a variety of ways, by the mobile device and/or other devices in communication with the mobile device, which may be situation dependent. For example, SPS satellites 110 may be used to provide global positioning, in which case the mobile device 105 can receive timing signals from the SPS satellites 110 using an SPS receiver and calculate a global position based on the received timing signals. In some embodiments, this calculation may additionally use data received by the location server 160.

As previously indicated, terrestrial positioning may also provide a location fix of the mobile device 105. This location fix may first involve determining distances between the mobile device 105 and one or more terrestrial transceivers (such as APs 130 and/or base transceiver stations 120). The mobile device 105 and/or terrestrial transceivers may measure the distance between the mobile device 105 and/or terrestrial transceivers (e.g., using wireless measurements such as round trip time (RTT), received signal strength indication (RSSI), angle of arrival (AOA), and/or the like). With these known locations and distance measurements, the position of the mobile device 105 can be calculated (e.g., by the mobile device 105, the location server 160, and/or another device) based on known locations of these terrestrial transceivers using trilateration, triangulation, and/or similar techniques. The location of the mobile device 105 can then be determined, which can be maintained by and/or accessible to the location server 160. (For example, the identification and known location of terrestrial transceivers can be maintained in a database and/or other data structure.)

In many instances, the mobile device 105 can be provided with assistance data from the location server 160 comprising a list of terrestrial transceivers with which distances can be measured. In particular, the mobile device 105 can send data to the location server 160 indicative of an approximate location of the mobile device. This data can include, for example, the identity of a serving transceiver (e.g., a serving base transceiver station or host AP) and/or one or more terrestrial transceivers detected by the mobile device 105. With this approximate location, the location server 160 can determine the identities and locations of various terrestrial transceivers (e.g., APs 130 and/or base transceiver stations 120) that may be near to the mobile device 105 and therefore potentially usable in a determination of the mobile device's location. This determination by the location server 160 can be made using a location database (or other data structure), which comprises the identities and locations of various terrestrial transceivers located in a geographical region served by the location server 160. The terrestrial transceivers determined to be near the mobile device can then be provided as assistance data to the mobile device. Hence, as used herein, the term “assistance data” can refer to information provided by a location server 160 that includes an indication of the identities of one or more terrestrial transceivers determined to be near the mobile device and usable for location determination.

As previously noted, however, traditional techniques of conducting measurements to terrestrial transceivers by the mobile device can be inefficient. For example, the assistance data may include a large amount of terrestrial transceivers with which the mobile device 105 can take distance measurements. (For example, a list of 24 to 72 cells may be provided to the mobile device 105. Other instances may have assistance data with fewer or the greater amount of cells, depending on desired functionality.) However, the mobile device 105 may only detect and/or determine its distance to only a fraction of the terrestrial transceivers of the assistance data. Some traditional techniques, for example, will have a mobile device 105 continue to attempt to take measurements with terrestrial transceivers that it has failed to take measurements with previously, no matter how many previous failed attempts were made at doing so. These traditional techniques are therefore not responsive to terrestrial environment changes or base transceiver station (cell) handoffs (such as handoffs between two of base transceiver stations 120), and the traditional techniques fail to handle ping-pong scenarios (in which a mobile device 105 at the border of a coverage area will toggle between two different host terrestrial transceivers) in an efficient manner.

Additionally, where the mobile device 105 also includes data connectivity functionality in which the mobile device 105 detects terrestrial transceivers for the purpose of establishing data connectivity (such as using a long-term evolution (LTE) searcher that scans for LTE transceivers for connectivity purposes (rather than location determination purposes)), traditional location measurement strategies typically ignore transceiver detection results provided by this functionality. These inefficiencies can delay a position fix (including TTFF) and consume power and processing resources, causing the user experience to suffer.

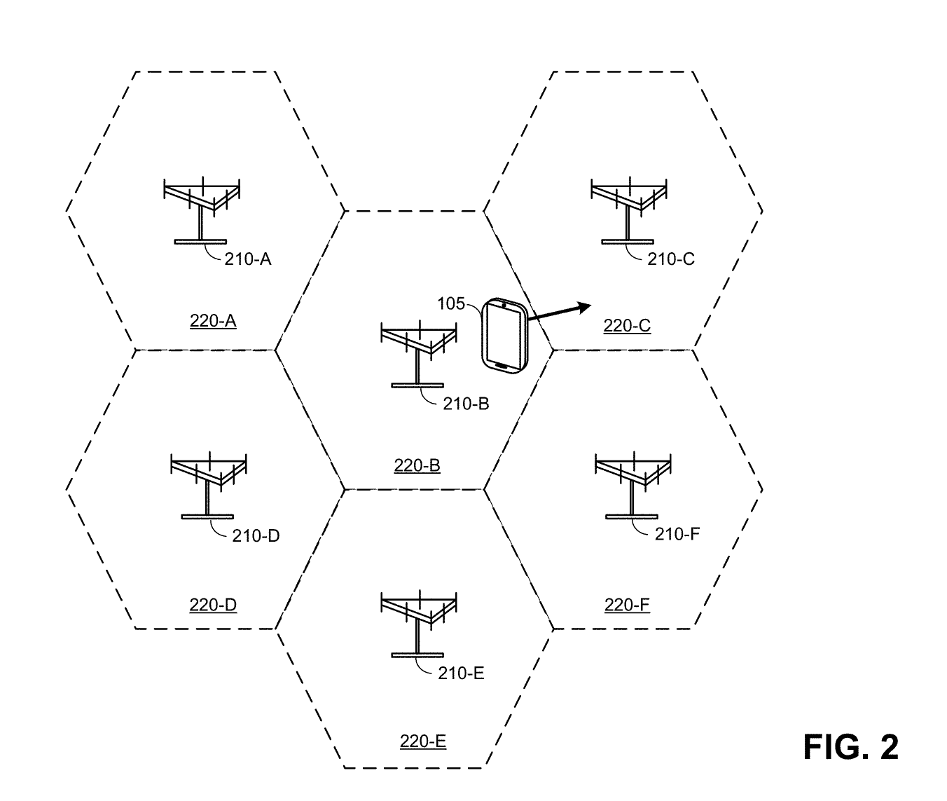

FIG. 2 is a simplified overhead illustration of a geographic area provided to help illustrate scenarios in which traditional measurement strategies may be inefficient, and how the techniques provided herein can be advantageous. Here, a plurality of terrestrial transceivers 210-A, 210-B, 210-C, 210-D, 210-E, and 210-F (collectively referred to as terrestrial transceivers 210) are pictured, each servicing a corresponding service area 220-A, 220-B, 220-C, 220-D, 220-E, and 220-F (collectively referred to as service areas 220). It is noted that terrestrial transceivers 210 are pictured as base transceiver stations, although the scenario described in FIG. 2 can apply to terrestrial transceivers of other types (e.g., base stations, beacons, etc.) and employing other wireless technologies (e.g., Wi-Fi®, Bluetooth®, etc.). FIG. 2 is provided as an example and, as such, a person of ordinary skill in the art will appreciate that different scenarios may include variations to the features shown, such as variations in the sizes, shapes, and distribution of service areas 220, locations of terrestrial transceivers 210 in relation to each other and/or within corresponding service areas 220, and so forth.

The scenario illustrated in FIG. 2 shows a mobile device 105 located near the edge of a first service area 220-B of a first terrestrial transceiver 210-B. Here, the mobile device 105 may receive assistance data from a location server (not shown) comprising a first list of terrestrial transceivers with which the mobile device 105 may attempt to take distance measurements. The location server may determine the terrestrial transceivers to include in the first list based on the identity of the first terrestrial transceiver 210-B (as the terrestrial transceiver serving first service area 220-B), which may be provided to the location server by the mobile device. (This identity may be determined by the mobile device 105 from, for example, beacon information and/or other communications between the mobile device 105 and the first terrestrial transceiver 210-B.) The first list may include, for example, each of the other terrestrial transceivers 210 in FIG. 2 (and perhaps other terrestrial transceivers not shown) due to their proximity to first terrestrial transceiver to 210-B. With this first list of terrestrial transceivers (comprising identification information of each of the listed terrestrial transceivers), the mobile device can then attempt to take distance measurements with each of them.

When the mobile device 105 crosses into a second service area 220-C, the mobile device 105 may indicate to a location server that it is now serviced by a second terrestrial transceiver 210-C. In this case, the location server may then provide new assistance data to the mobile device 105 comprising a second list of terrestrial transceivers. Because of the proximity of the second terrestrial transceiver 210-C with the first terrestrial transceiver 210-B, the first and second lists of terrestrial transceivers may include many of the same terrestrial transceivers. Nonetheless, the mobile device 105 may attempt to take distance measurements with each of the terrestrial transceivers on the second list of terrestrial transceivers, regardless of whether the mobile device's previous attempts to connect with the terrestrial transceivers were successful.

For example, because terrestrial transceiver 210-E is proximate to both first terrestrial transceiver 210-B and second terrestrial transceiver 210-C, it may be included on both first and second lists of terrestrial transceivers. However, even if the mobile device 105 had several unsuccessful attempts at taking measurements with the terrestrial transceiver 210-E while the mobile device is in the first service area 220-B, traditional terrestrial positioning techniques may cause the mobile device 105 to again attempt to take measurements with the terrestrial transceiver 210-E when the mobile device 105 receives the second list of terrestrial transceivers after mobile device moves to the second service area 220-C. This problem may be exacerbated if the mobile device 105 remains near the border of the first service area 220-B and the second service area 220-C, frequently switching between the two, creating a “ping-pong” scenario as previously mentioned. Each time the mobile device receives a list of terrestrial transceivers associated with a service area, the mobile device 105 may attempt to take distance measurements with the terrestrial transceivers without regard to whether it had any previous success in doing so, likely resulting in spending time and other resources attempting to take distance measurements with terrestrial transceivers for which it has a low probability of success at taking a distance measurement.

Techniques provided herein address these and other issues by having a mobile device (e.g., a mobile device 105 as shown in FIGS. 1 and 2) to maintain a history indicating the success of previous attempts to take measurements with terrestrial transceivers for location determination. This history can be used to prioritize terrestrial transceivers with which future measurement attempts are to be made. According to some embodiments, this history can be organized and maintained in a database or other data structure, and accumulated in real-time to minimize processing and allow on-the-fly generation of the prioritized list of terrestrial transceivers with which future measurement attempts are to be made.

According to some embodiments, this history can include information received by a positioning measurement engine used for position determination and/or an data connectivity searcher of the mobile device used for data connectivity. (It is noted that, although the previous description of a data connectivity searcher involved LTE, embodiments are not so limited. Other embodiments may utilize alternative functionality where other technologies (other than LTE) and/or other functions are performed.) That said, some embodiments may not use a data connectivity searcher, but may instead prioritize taking measurements based only on assistance data and prior measurement success. As described in more detail below, this terrestrial transceiver information stored by the mobile device is used to prioritize the terrestrial transceivers with which the mobile device takes measurements for location determination.

In some embodiments, the terrestrial transceiver history maintained by a mobile device may categorize terrestrial transceivers listed in both current and prior assistance data to help facilitate position fixes where movement between current and previous locations takes place, among other situations. In some embodiments, the mobile device may categorize each terrestrial transceiver as being included in one of six groups of terrestrial transceivers: three groups of “new” terrestrial transceivers (terrestrial transceivers received in newly-received assistance data), and three groups of “aging” terrestrial transceivers (terrestrial transceivers received in prior assistance data). (Of course these labels are arbitrary. Embodiments may utilize databases in which the functionality described herein is implemented without labels or with different labels.)

The three groups of “new” terrestrial transceivers include:
“Found” (F). These are terrestrial transceivers in the newly-received assistance data for which, according to the terrestrial transceiver history, the mobile device has successfully taken a distance measurement.
“Not found” (N). These are terrestrial transceivers in the newly-received assistance data for which, according to the terrestrial transceiver history, the mobile device has not successfully taken a distance measurement.
“Should be found” (S). These are terrestrial transceivers in the newly-received assistance data for which, according to the terrestrial transceiver history, the mobile device has not made an attempt to take a distance measurement.

The three groups of “aging” terrestrial transceivers include:
“Aging Found” (AF). These are terrestrial transceivers that are not in the newly-received assistance data but were in prior assistance data, for which the mobile device has successfully taken a distance measurement.
“Aging Not found” (AN). These are terrestrial transceivers that are not in the newly-received assistance data but were in prior assistance data, for which the mobile device has not successfully taken a distance measurement.
“Aging Should be found” (AS). These are terrestrial transceivers that are not in the newly-received assistance data but were in prior assistance data, for which the mobile device has not made an attempt to take a distance measurement.

As can be seen, these groups provide an indication of whether an attempt to make a distance measurement to a terrestrial transceiver is successful/unsuccessful or has been successful/unsuccessful in the recent past, as well as an indication of terrestrial transceivers with which such an attempt has not yet been made. Alternative embodiments may use alternative techniques and/or groups to perform a similar functionality.

The process of generating and maintaining the terrestrial transceiver history may generally proceed as follows. When newly-received assistance data is provided by a location server to a mobile device, the mobile device can change the grouping of any terrestrial transceivers currently in the terrestrial transceiver history (that may have been received from prior assistance data) from F, N, and S groups into the AF, AN, and AS groups, respectively. (The AF, AN, and AS groups therefore provide a history of terrestrial transceivers that were formerly in the respective F, N, and S groups.) All terrestrial transceivers listed in the newly-received assistance data can then be put into the F, N, and S groups. Terrestrial transceivers in the new assistance data that are also listed in the AF and AN groups can be put into F and N groups respectively. All other terrestrial transceivers in the new assistance data will be put into the S group.

With this categorization of terrestrial transceivers in the newly-received assistance data, the mobile device can then conduct measurements with terrestrial transceivers in the F, N, and S groups based on a prioritization of those groups. Specifically, the mobile device can prioritize attempt to take distance measurements with terrestrial transceivers the F group (which are most likely to be found) first, the S group (which may be found) next, and, time permitting, the N group (which are least likely to be found) last. Depending on desired functionality, measurement attempts to terrestrial transceivers in the N group may be done in round-robin fashion and/or may be limited by time limits and/or other limitations that may impact the measurement attempts.

Using this prioritization, a mobile device is more likely to obtain a position fix faster than obtaining the position fix without this prioritization, because it prioritizes taking measurements from cells that are most likely to be found first. The mobile device can also make any adjustments to the F, N, and S groups, based on the results of the measurement attempts to terrestrial transceivers in these groups. For example, if a terrestrial transceiver in the F group is “not found” (that is, the mobile device was unable to make a distance measurement with the terrestrial transceiver), it can be moved to the N group. Any terrestrial transceivers in the S group can be moved to the F or N group accordingly (depending on whether the mobile device was successful in its attempt at making a distance measurement), and a terrestrial transceiver in the N group may be moved to the F group if it is found (that is, the mobile device was able to make a distance measurement with the terrestrial transceiver).

Later, when a new set of assistance data is received, transceivers in the F, N, and S groups can be moved to the AF, AN, and AS groups, respectively. Furthermore, as discussed in further detail below, terrestrial transceivers previously in the AF, AN, and AS groups may be removed from those groups where their “age” (e.g., length of time and/or number of events occurred while terrestrial transceivers are within those groups) exceeds a certain threshold.

As an example, a mobile device may receive a list of 100 terrestrial transceivers in assistance data. If this is the first set of assistance data the cell phone has received (or if this is the first set of assistance data in a long time, after all previous assistance data has “aged out” of the AF, AN, and/or AS groups) then the mobile device will initially put all 100 terrestrial transceivers into the S group. According to some embodiments, the mobile device can take measurements of portions of the 100 terrestrial transceivers (for example, 10 at a time). For example, with the first 10 terrestrial transceivers, the mobile device may only be able to take measurements of 4 terrestrial transceivers, failing to take measurements of the remaining 6. In that case, the 4 terrestrial transceivers that were found would be put in the F list, and the remaining 6 would be put in the N list. The remaining 90 terrestrial transceivers of the assistance data would be grouped in a similar way, 10 at a time, until all 100 terrestrial transceivers received in the assistance data are put into either the F list or the N list. (In instances where the mobile device is unable to attempt to take measurements from some terrestrial transceivers, these terrestrial transceivers may remain in the S group.)

The example provided above described the terrestrial transceivers being measured 10 at a time, but embodiments may vary depending on desired functionality. In general, dividing the list of terrestrial transceivers of the assistance data into smaller groups in this manner can provide for overall efficiency gains, enabling the mobile device to perform other functions between taking measurements. (Otherwise, attempting to take measurements for all terrestrial transceivers in the assistance data may take a lot of time and processing power.) Furthermore, a mobile device may be able to obtain a position fix after performing measurements on a subset of the terrestrial transceivers in the assistance data, rather than after performing measurements (or attempting to perform measurements) on every terrestrial transceiver. Accordingly, prioritizing the attempted measurements by using the groups described herein can provide for efficiencies where the mobile device is able to get a position fix after taking measurements from only a portion of the terrestrial transceivers included in the assistance data.

According to some embodiments, a mobile device may follow rules for creating and maintaining the previously described groups, according to an embodiment. In particular, according to embodiments, no terrestrial transceiver may be in more than one group. As noted earlier, terrestrial transceivers in the assistance data will be assigned to be in the F, N, or S group. And any terrestrial transceivers in the AF, AN, or AS groups will be placed in the F, N, or S group, respectively. This enables the mobile device to conduct measurements in a prioritized fashion, as previously described, as well as maintain historical data to inform this prioritization. (E.g., by terrestrial transceivers from moving the AF, AN, or AS group to the F, N, or S group.)

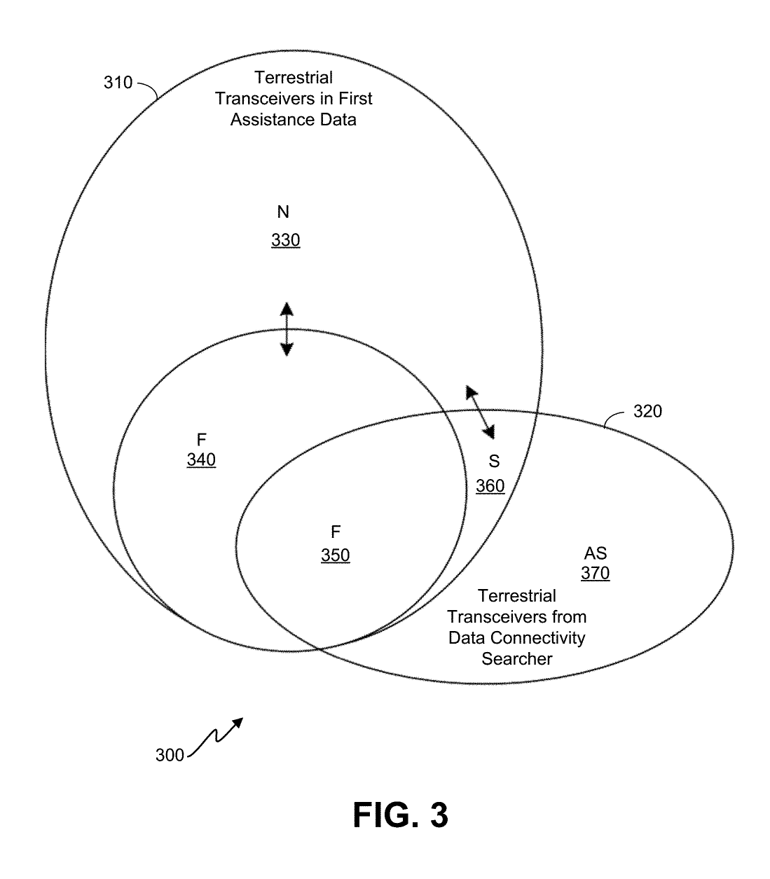

FIGS. 3-5 are Venn diagrams that illustrate the relationship between assistance data, data received by a data connectivity searcher (such as an LTE searcher that scans for LTE transceivers for connectivity purposes), and the various groups of terrestrial transceivers described herein, according to an embodiment. Of course, embodiments are not so limited. In alternative embodiments, terrestrial transceiver information may be generated and/or provided by additional and/or alternative software modules and/or devices. In some embodiments, for example, a mobile device may receive assistance data from a plurality of sources, including a plurality of remote devices.

FIG. 3 shows a Venn diagram 300 illustrating how terrestrial transceivers in a group of terrestrial transceivers in a first assistance data 310 received by a mobile device and a group of terrestrial transceivers from a data connectivity searcher 320 of the mobile device may be related, and how they may be categorized by the mobile device into the groups described above. It can be noted that terrestrial transceivers from a data connectivity searcher 320 may be obtained before or after the first assistance data 310 is received, depending on the situation. (In either case, the terrestrial transceivers from a data connectivity searcher 320 may be categorized once the first assistance data 310 is received.) Here, the terrestrial transceivers in the first assistance data 310 are put into the N group 330, the F group 340/350, or the S group 360.

In the case where the mobile device received previous assistance data and had a terrestrial transceiver history with AN, AF, or AS groups, the mobile device would put the terrestrial transceivers in the first assistance data 310 into the N group 330, the F group 340/350, or the S group 360 respectively. Terrestrial transceivers that are not in the AF, AN, or AS groups would initially be in the S group 360 until the mobile device makes measurement attempts with those terrestrial transceivers, at which point the mobile device would put the terrestrial transceivers into the N group 330 or the F group 340/350 (depending on whether a measurement attempt was successful). Similarly, where the mobile device does not have a terrestrial transceiver history (at least not for any of the terrestrial transceivers in the first assistance data 310), all of the terrestrial transceivers in the first assistance data 310 would initially be in the S group 360 until measurement attempts are made.

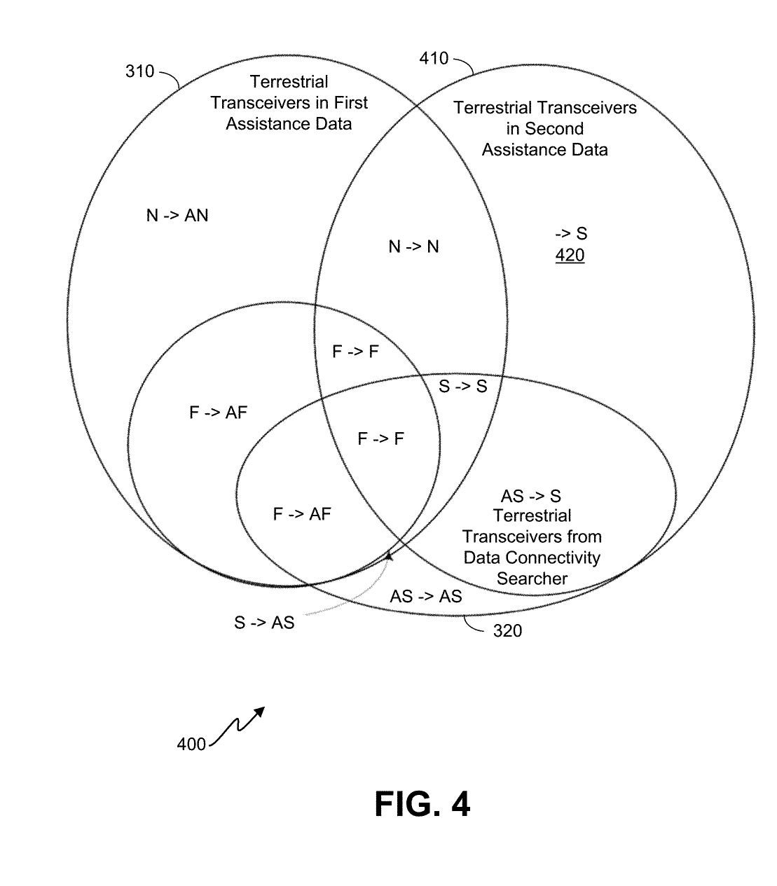

Notably, the Venn diagram 300 in FIG. 3 further includes how terrestrial transceivers from a data connectivity searcher 320 may also be grouped. Here, terrestrial transceivers that are also among the terrestrial transceivers in the first assistance data 310 may either be in group F 350 or, if they are not in group F 350, they can be put in group S 360 (under the presumption that, if a measurement attempt has not yet been attempted, it should be successful because the terrestrial transceiver has been detected by the data connectivity searcher). Additionally, terrestrial transceivers that are not in the assistance data are put in the AS group 370. As indicated herein below, this can allow them to be prioritized if they are included in subsequent assistance data (e.g., by being put in the S group, as shown in FIG. 4). (In some embodiments, these terrestrial transceivers may be included in the AF group (not shown).)

FIG. 4 is a Venn diagram 400 showing how, according to an embodiment, the receipt of terrestrial transceivers in a second assistance data 410 data can impact the previous groupings of terrestrial transceivers in the first assistance data 310 and terrestrial transceivers from a data connectivity searcher 320 illustrated in FIG. 3. Because the terrestrial transceivers in the second assistance data 410 does not overlap entirely with the terrestrial transceivers in the first assistance data 310, the terrestrial transceivers in the second assistance data 410 may be reflective of a change location of the mobile device (at least as perceived by the location server or other device(s) providing the assistance data).

Groupings of terrestrial transceivers in the first assistance data 310 that do not overlap with the new assistance data will be sent to aging groups. That is, as shown in FIG. 400, non-overlapping terrestrial transceivers in the first assistance data 310 in the N group will be put in the AN group, those in the F group will be put in the AF group, and those in the S group (if any) will be put in the AS group. The terrestrial transceivers in these aging groups (AN, AF, and AS) can be maintained in their respective aging groups for a certain period of time, depending on desired functionality. As noted below, the period of time that terrestrial transceivers can be maintained in aging groups can vary, and may be customized on a per user or per device per basis, for example. Again, maintaining these aging lists can enable the mobile device to, in cases where the mobile device returns to a previous location (and receives the original assistance data), group the terrestrial transceivers in the aging lists into N, F, and S groups, and prioritize measurements with these terrestrial transceivers accordingly, resulting in a quicker position fix than if these terrestrial transceivers were not prioritized. This helps speed up position fixes in the case of a “ping-pong” scenario in which the mobile device moves between two different coverage regions (e.g., regions corresponding to two different sets of assistance data).

As indicated in the diagram, terrestrial transceivers included in both the terrestrial transceivers in the first assistance data 310 and terrestrial transceivers in the second assistance data 410 they maintain the grouping of the original assistance data. That is, terrestrial transceivers in the F, N, and S groups will remain in their respective groups. Additionally, terrestrial transceivers from the data connectivity searcher 320 that are also listed among the terrestrial transceivers in the second assistance data 410 will move from the AS group to the S group. (In embodiments where they were previously in the AF group, they may be put in the F group, for even higher prioritization.) Those terrestrial transceivers from the data connectivity searcher 320 but not included in the terrestrial transceivers in the first assistance data 310 or the terrestrial transceivers in the second assistance data 410 will remain in the AS group (or AF group, depending on the embodiment).

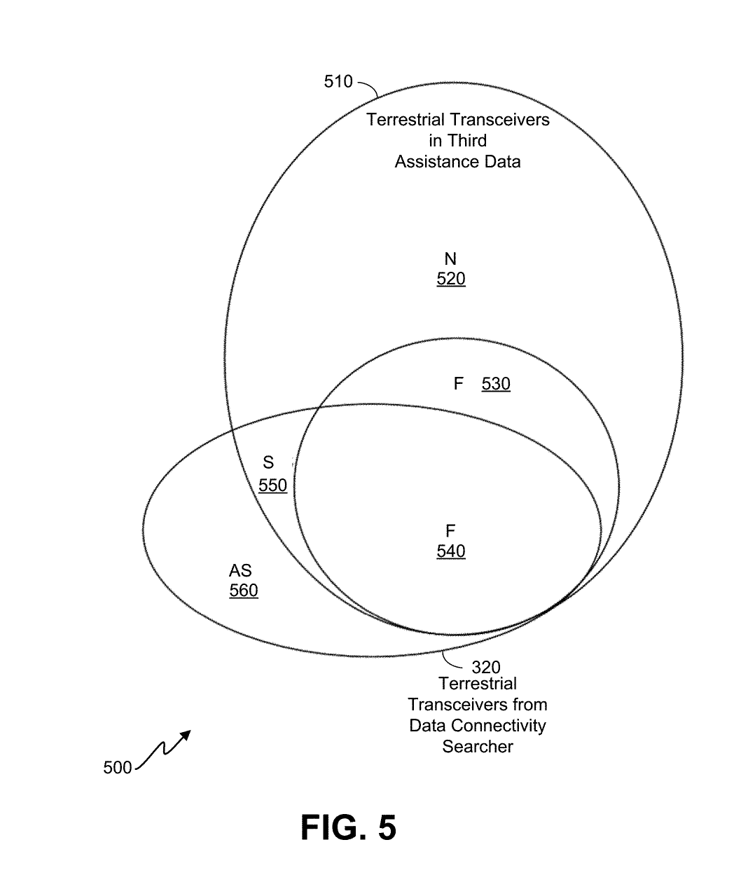

FIG. 5 is a Venn diagram 500 showing an embodiment of how the grouping of terrestrial transceivers of FIG. 4 are impacted if the mobile device receives a third assistance data in which terrestrial transceivers in the third assistance data 510 wholly overlap with terrestrial transceivers in the second assistance data 410. That is, the mobile device is provided with assistance data having the same list of terrestrial transceivers because the location server (or other device(s) providing the assistance data) perceives the mobile device as being in the same approximate location. (As explained before, this can be due to the mobile device being connected with the same serving terrestrial transceiver at the time it requested and/or received both the second and third assistance data.) In the manner described above, terrestrial transceivers in the third assistance data 510 are grouped in the N group 520, F group 530/540, or S group 550 based on how they were previously grouped by the mobile device after receiving the second assistance data and/or subsequent measurement attempts by the mobile device.

Here, terrestrial transceivers in the first assistance data 310 that were in the aging groups AF, AN, and AS, are ultimately removed (or “aged out”) from the aging groups (and from the terrestrial transceiver history entirely). In other words, the terrestrial transceivers in the aging lists were on the aging lists for over a threshold amount of time, at which point they were removed from the aging lists. This functionality can help improve memory management because they can remove terrestrial transceivers that are ultimately unlikely to be found after a certain period of time. As shown, however, the terrestrial transceivers from the data connectivity searcher 320 may still include terrestrial transceivers that are not included in the terrestrial transceivers in the third assistance data 510, in which case these terrestrial transceivers remain in the AS group 560.

The time it takes for a terrestrial transceiver to be removed from an aging list (and purged from the terrestrial transistor history) can vary, depending on desired functionality. In some instances, for example, this may be a set period of time, such as 60 seconds for example. In some embodiments, removal may be event based. For example, terrestrial transceivers may be kept on an aging list for a certain number of times assistance data is subsequently received (e.g., after receiving assistance data from the location server 10 times). In some embodiments, a threshold of events may vary, depending on the type of event. For example, a terrestrial transceiver may be “aged out” of the terrestrial transceiver history if not included in assistance data the next 10 times assistance data is received, or is not included in a list of terrestrial transceivers from a data connectivity searcher next five times the data connectivity searcher list is received.

In some embodiments, the threshold related to removing terrestrial transceivers from the terrestrial transceiver history may depend on the wireless technology (or technologies) involved. For example, where terrestrial transceivers are base transceiver stations (e.g., cellular base stations), the threshold of time that the terrestrial transceiver is maintained on an aging list may be longer than where the terrestrial transceivers are Wi-Fi APs because the coverage area of a base transceiver station is much larger than the coverage area of a Wi-Fi AP. Additionally or alternatively, a determined speed of the mobile device may impact the threshold of time that the terrestrial transceiver is maintained in an aging group. If a mobile device is moving at a relatively quick pace, for example, it is more likely to move between geographical regions at a faster rate, in which case terrestrial transceivers may be maintained in aging groups for a relatively shorter period of time than when the mobile device is moving at a slower pace.

According to some embodiments, the mobile device may provide feedback to the location server, to help the location server optimize the assistance data for particular coverage region. For example, in cases where terrestrial transceivers received from a data connectivity searcher of the mobile device do not overlap with terrestrial transceivers received in assistance data received by a location server, the mobile device may provide the location server with a list of the terrestrial transceivers received from the data connectivity searcher. Because these terrestrial transceivers are detected by the mobile device, these terrestrial transceivers can potentially be used for location determination purposes. As such, the location server may subsequently include these terrestrial transceivers in assistance data for a particular coverage region corresponding to the assistance data, where possible, enabling the mobile device (and/or other mobile devices) to use those terrestrial transceivers for a subsequent position fix in that coverage region.

In addition to the rules of grouping described above, a mobile device may implement one or more additional grouping rules to update the groupings of terrestrial transceivers in the terrestrial transceiver history based on certain events. For example, in embodiments where a data connectivity searcher provides a list of terrestrial transceivers, terrestrial transceivers on that list that are currently in the N group may be moved to S group, giving them a higher priority based on the fact that they were detected by the data connectivity searcher. Terrestrial transceivers on the list from the data connectivity searcher that were previously in the F and S groups can remain in those respective groups. As indicated in the embodiments illustrated in FIGS. 3-5, any other terrestrial transceivers on the list from the data connectivity searcher can be included in the AS group (or AF group, depending on desired functionality), which begins aging. Once the mobile device settles in one coverage area where no new terrestrial transceivers are included in assistance data, the terrestrial transceivers that are included in the assistance data can be processed in the manner described in the embodiments above.

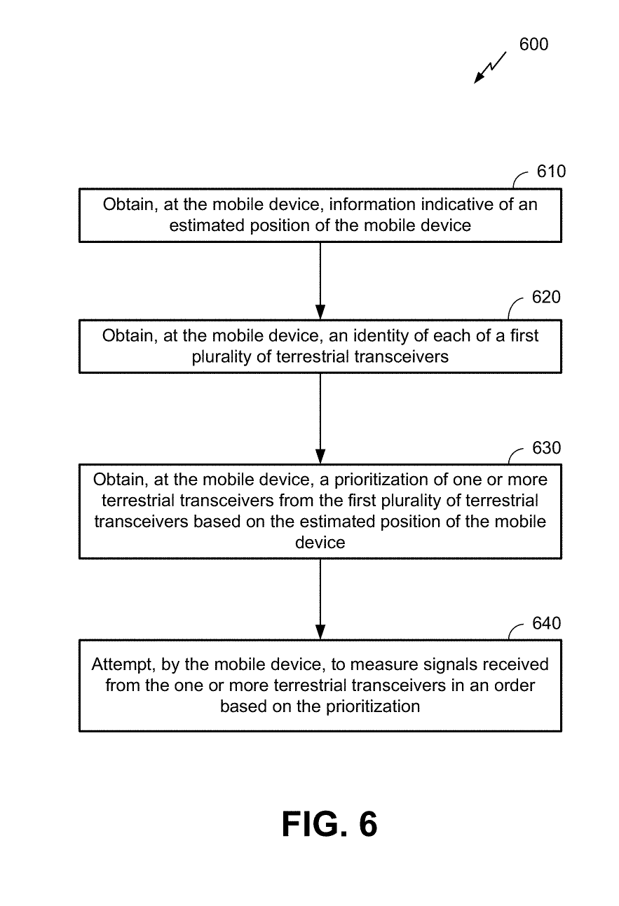

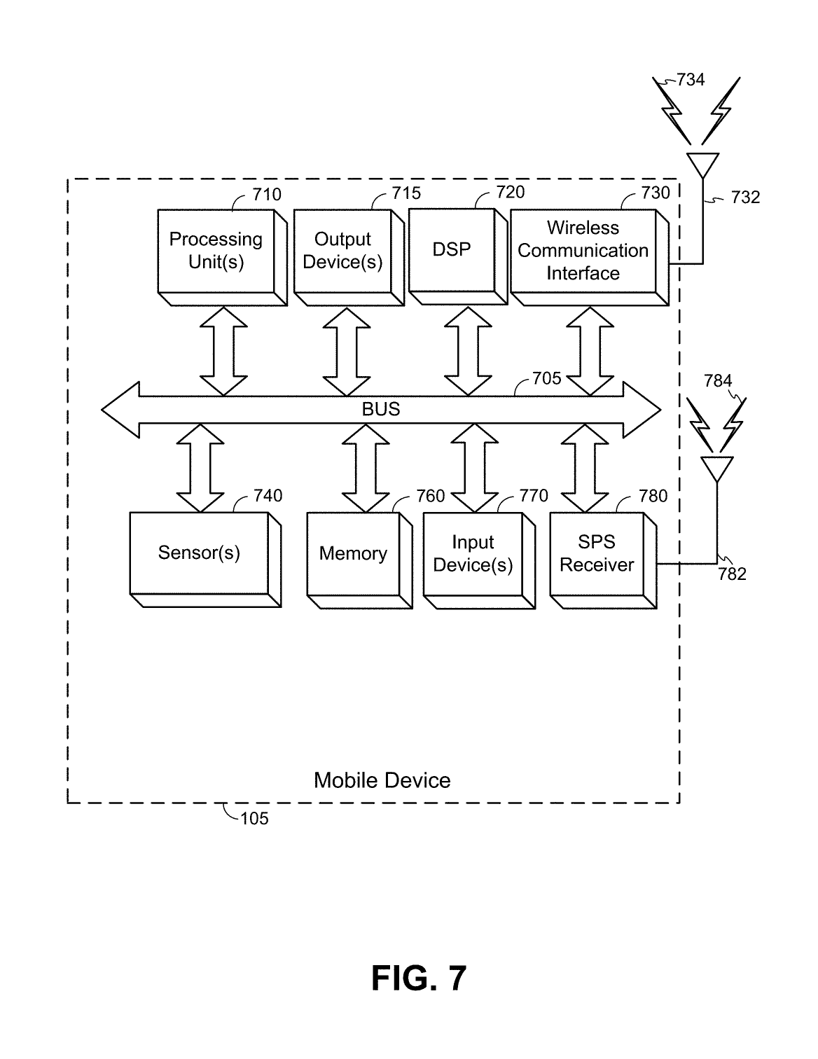

FIG. 6 is a flow diagram of a method 600 of taking measurements for position location by a mobile device, according to an embodiment. It will be understood, however, that the functionality illustrated in the blocks shown in FIG. 6, may vary, depending on desired functionality. Alternative embodiments can, for example, combine, separate, omit, and/or add to the functions illustrated. A person of ordinary skill in the art will appreciate such variations. According to some embodiments, the functionality of all or a portion of the blocks shown in FIG. 6 software and/or hardware components of a mobile device, such as the mobile device 105 illustrated in FIG. 7.

At block 610 the method comprises obtaining, at the mobile device, information indicative of an estimated position of the mobile device. As previously indicated, this information may comprise an identity of a serving terrestrial transceiver with which the mobile device is communicatively coupled. Additionally or alternatively, the mobile device may determine an identity of a terrestrial transceiver via a beacon or other communication received and/or detected from the terrestrial transceiver. This information can be indicative of a location of the mobile device because the location of the serving and/or detected terrestrial transceiver may be known (e.g., to a location server). Other information indicative of an estimated location may comprise, for example, an estimated location based on other information available to the mobile device (e.g., based on SPS information, dead reckoning information based on sensor data, etc.). In some embodiments, for example, this may even include user input. The functionality of block 610 can be performed using various hardware/and/or software means of a mobile device 105, including the processing unit(s) 710, wireless communication interface 730, bus 705, sensor(s) 740, memory 760, input device(s) 770, SPS receiver 780, and/or other components of a mobile device 105 as illustrated in FIG. 7, described in more detail below.

Block 620 includes obtaining, at the mobile device, an identity of each of a first plurality of terrestrial transceivers. This information can be obtained by, for example, receiving the identity of each of the first plurality of terrestrial transceivers from one or more location servers. Receiving this information, which may be included in assistance data from a location server, may be triggered by first sending the information indicative of the estimated position of the mobile device. As previously indicated, a location server may maintain and/or have access to location information for terrestrial transceivers that may be detectable by the mobile device, based on the mobile device's estimated position. The location server may therefore generate information comprising the identity of each of the first plurality of terrestrial transceivers and provide it to the mobile device. In some embodiments, assistance data may further provide a location of each of the first plurality of terrestrial transceivers (enabling the mobile device to calculate its own location).

The functionality of block 620 can be performed using various hardware/and/or software means of a mobile device 105, including the processing unit(s) 710, wireless communication interface 730, bus 705, memory 760, and/or other components of a mobile device 105 as illustrated in FIG. 7, described in more detail below.

The functionality at block 630 comprises obtaining, at the mobile device, a prioritization of one or more terrestrial transceivers from the first plurality of terrestrial transceivers based on the estimated position of the mobile device. Here, because the mobile device may maintain a terrestrial transceiver history indicative of whether or not past attempts at taking measurements with certain terrestrial transceivers were successful, and because this terrestrial transceiver history may purge old information (e.g., after a threshold period of time), this history can be reflective of the mobile device's estimated position and may enable the mobile device to prioritize terrestrial transceivers from the first plurality of terrestrial transceivers. Moreover, because the first plurality of terrestrial transceivers is also based on the devices estimated position, the prioritization of the one or more terrestrial transceivers from the first plurality of terrestrial transceivers itself is based on the estimated position of the mobile device.

As previously indicated, obtaining the prioritization of one or more terrestrial transceivers from the first plurality of terrestrial transceivers can be done by maintaining a terrestrial transceiver history. In particular, obtaining the prioritization can comprise attempting, in a prior attempt, to measure signals received from the one or more terrestrial transceivers from the first plurality of terrestrial transceivers. The success of these attempts can be stored and used for later prioritization. As such, the method 600 can further comprise storing, for each terrestrial transceiver of the first plurality of terrestrial transceivers, information associating the prior estimated location of the mobile device with an indication of whether the prior attempt to measure signals received from the one or more terrestrial transceivers from the first plurality of terrestrial transceivers was successful.

The functionality of block 630 can be performed using various hardware/and/or software means of a mobile device 105, including the processing unit(s) 710, bus 705, sensor(s) 740, memory 760, and/or other components of a mobile device 105 as illustrated in FIG. 7, described in more detail below.

At block 640, the functionality includes attempting, by the mobile device, to measure signals received from the one or more terrestrial transceivers in an order based on the prioritization. In some implementations, this can include attempting to measure a previously found terrestrial transceiver before attempting to measure a previously not found terrestrial transceiver (with which measurement attempts were made). Additionally or alternatively, this can comprise attempting to measure a terrestrial transceiver with which a measurement attempt was not previously made before attempting to measure a previously not found terrestrial transceiver. Embodiments may additionally or alternatively attempt to measure a previously found terrestrial transceiver before attempting to measure a terrestrial transceiver with which a measurement attempt was not previously made. In some embodiments, a terrestrial transceiver identified by a data connectivity searcher may be prioritized in a manner similar to a terrestrial transceiver with which a measurement attempt was not previously made (even if a measurement attempt was, in fact, made) As mentioned previously, these signal-measuring attempts can be attempts to measure distance using RSSI, RTT, and/or other techniques in which signals received from a terrestrial transceiver are used to determine distance.

The position of the mobile device can then be computed based on the measurements of signals received from the one or more terrestrial transceivers from the first plurality of terrestrial transceivers. The mobile device itself can make this computation or, alternatively, the mobile device may send measurement results to the location server (or other device) to calculate the position of the mobile device.

Here, the computed position of the mobile device is more accurate than the estimated position of the mobile device. That is, the calculation (e.g., using the distance measurements to perform trilateration and/or calculate a position in a similar manner) results in a relatively accurate location determination (based on the accuracy of the known locations of the terrestrial transceivers, the distance measurements, and the like) compared with the estimated position of the mobile device, which is used to determine which terrestrial transceivers to include in the first plurality of terrestrial transceivers.

The functionality of block 640 can be performed using various hardware/and/or software means of a mobile device 105, including the processing unit(s) 710, wireless communication interface 730, bus 705, sensor(s) 740, memory 760, and/or other components of a mobile device 105 as illustrated in FIG. 7, described in more detail below.

Alternative embodiments of the method 600 may include additional features, depending on desired functionality. Some embodiments may enable a mobile device may use information received from a data connectivity searcher, for example. In such instances, the method may further comprise, subsequent to obtaining the identity of each terrestrial transceiver of the first plurality of terrestrial transceivers, obtaining an identity of each terrestrial transceiver of a second plurality of transceivers, wherein the second plurality of terrestrial transceivers includes the one or more terrestrial transceivers from the first plurality of terrestrial transceivers. Here, the identity of each terrestrial transceiver of the first plurality of terrestrial transceivers in the identity of each terrestrial transceiver of the second plurality of terrestrial transceivers can be obtained from different sources (e.g., the former from assistance data received from a location server, and the latter from a data connectivity searcher). Moreover, some embodiments may allow the mobile device to provide feedback to a location server based on information received from a data connectivity searcher, which can be used by the location server to help provide more accurate assistance data. From the perspective of the method 600, this may involve obtaining an identity of each terrestrial transceiver of a second plurality of terrestrial transceivers detected by the mobile device (e.g., by the data connectivity searcher of the mobile device), and sending, to the location server, the identity of at least one terrestrial transceiver of the second plurality of terrestrial transceivers not included in the first plurality of terrestrial transceivers.

Some embodiments may utilize different techniques for purging (or “aging out”) information regarding terrestrial transceivers (e.g., identity, category or group, location, etc.). As such, the method 600 may further comprise, for at least one terrestrial transceiver of the first plurality of terrestrial transceivers, purging stored information indicative of whether the attempt to measure signals received from the at least one terrestrial transceiver of the first plurality of terrestrial transceivers was successful. Depending on desired functionality, this purging can occur after a threshold period of time has elapsed since the attempt to measure signals received from the at least one terrestrial transceiver, or after receiving, from at least one location server, assistance data a threshold number of times.

FIG. 7 is illustrates an embodiment of a mobile device 105, which can be utilized in the embodiments described herein. In other words, means for performing some or all of the functions of a mobile device, as described in the embodiments provided herein, may include software and/or hardware components of a mobile device, as illustrated in FIG. 7 and described in further detail below. It should be noted that FIG. 7 is meant only to provide a generalized illustration of various components, any or all of which may be utilized as appropriate. In other words, because mobile devices can vary widely in functionality, they may include only a portion of the components shown in FIG. 7. It can be noted that, in some instances, components illustrated by FIG. 7 can be localized to a single physical device and/or distributed among various networked devices, which may be disposed at different physical locations.

The mobile device 105 is shown comprising hardware elements that can be electrically coupled via a bus 705 (or may otherwise be in communication, as appropriate). The hardware elements may include a processing unit(s) 710 which may comprise without limitation one or more general-purpose processors, one or more special-purpose processors (such as digital signal processing (DSP) chips, graphics acceleration processors, application specific integrated circuits (ASICs), and/or the like), and/or other processing structure or means, which can be configured to perform one or more of the methods described herein. As shown in FIG. 7, some embodiments may have a separate DSP 720, depending on desired functionality. The mobile device 105 also may comprise one or more input devices 770, which may comprise without limitation one or more touch screens, touch pads, microphones, buttons, dials, switches, and/or the like; and one or more output devices 715, which may comprise without limitation, one or more displays, light emitting diode (LED)s, speakers, and/or the like.

The mobile device 105 might also include a wireless communication interface 730, which may comprise without limitation a modem, a network card, an infrared communication device, a wireless communication device, and/or a chipset (such as a Bluetooth® device, an Institute of Electrical and Electronics Engineers (IEEE) 802.11 device, an IEEE 802.15.4 device, a Wi-Fi® device, a WiMax® device, cellular communication facilities, etc.), and/or the like. The wireless communication interface 730 may permit data (such as assistance data, location information, and/or other information) to be communicated with a network, a location server, terrestrial transceivers, other computer systems, and/or any other electronic devices described herein. The communication can be carried out via one or more wireless communication antenna(s) 732 that send and/or receive wireless signals 734.

Depending on desired functionality, the wireless communication interface 730 may comprise one or more transceivers to communicate with terrestrial transceivers, such as base transceiver stations, Wi-Fi access points (APs), wireless beacons, and/or other such transceivers. These different data networks may comprise various network types. A wireless wide area network (WWAN), for example, may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other radio access technology (RAT). An OFDMA network may employ LTE, LTE Advanced, and so on. LTE, LTE Advanced, GSM, and W-CDMA are described in documents from 3GPP. Cdma2000 is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The wireless communication interface 730 may further comprise hardware and/or software components for implementing one or more data connectivity searchers as described in the embodiments above. The implementation and/or functionality of such a data connectivity searcher may vary depending on the wireless technology involved (LTE, GSM, etc.), applicable protocols and/or standards, manufacturing concerns, and/or other factors.

The mobile device 105 can further include sensor(s) 740. Such sensors may comprise, without limitation, one or more accelerometer(s), gyroscope(s), camera(s), magnetometer(s), altimeter(s), microphone(s), proximity sensor(s), light sensor(s), and the like. Some or all of the sensor(s) 740 can be utilized, among other things, positioning methods.

Embodiments of the mobile device may also include an SPS receiver 780 capable of receiving signals 784 from one or more SPS satellites (e.g., SPS satellites 110 of FIG. 1) using an SPS antenna 782. In some embodiments, such satellite-based positioning can be utilized to complement the terrestrial transceiver-based positioning techniques described herein. The SPS receiver 780 can extract a position of the mobile device, using conventional techniques, from SPS satellites of an SPS system or global navigation satellite system (GNSS) (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, the SPS receiver 780 can be used various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile device 105 may further include and/or be in communication with a memory 760. The memory 760 may comprise, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like. This memory 760 may be used to store the groups of terrestrial transceivers (e.g., N, F, S, AN, AF, and AS) described herein, and/or another form of terrestrial transceiver history, which can be implemented using a database, linked list, or any other type of data structure. Additionally or alternatively, the groups of terrestrial transceivers may be stored in a separate memory utilized by dedicated hardware for terrestrial transceiver categorization as described herein. This memory (and dedicated hardware) may be located within the wireless communication interface 730.

The memory 760 of the mobile device 105 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the functionality discussed above, such as the method 600 of FIG. 6, might be implemented as code and/or instructions executable by the mobile device 105 (and/or a processing unit within a mobile device 105) (and/or another device of a positioning system). In an aspect, then, such code and/or instructions can be used to configure and/or adapt a general purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that may comprise memory may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

1. A method of taking measurements for position location by a mobile device, the method comprising:
obtaining, at the mobile device, information indicative of an estimated position of the mobile device;
sending the information indicative of an estimated position of the mobile device to a location server;
obtaining, at the mobile device, an identity of each terrestrial transceiver of a first plurality of terrestrial transceivers, the first plurality of terrestrial transceivers selected based on the information indicative of the estimated position of the mobile device;
obtaining, at the mobile device, a prioritization of one or more terrestrial transceivers from the first plurality of terrestrial transceivers based on:
the estimated position of the mobile device, and
a result of whether a prior attempt to measure signals received from the one or more terrestrial transceivers was successful or unsuccessful; and
attempting, by the mobile device, to measure signals received from the one or more terrestrial transceivers in an order based on the prioritization.

2. (canceled)

3. The method of claim 1, further comprising storing, for each terrestrial transceiver of the one or more terrestrial transceivers, information associating a prior estimated location of the mobile device with an indication of the result of whether the prior attempt to measure the signals received from the one or more terrestrial transceivers was successful.

4. The method of claim 1, further comprising computing a position of the mobile device based on measurements of signals received from the one or more terrestrial transceivers.

5. The method of claim 4, wherein the computed position of the mobile device is more accurate than the estimated position of the mobile device.

6. The method of claim 1, further comprising, subsequent to obtaining the identity of each terrestrial transceiver of the first plurality of terrestrial transceivers, obtaining an identity of each terrestrial transceiver of a second plurality of terrestrial transceivers, wherein the second plurality of terrestrial transceivers includes the one or more terrestrial transceivers.

7. The method of claim 6, wherein the identity of each terrestrial transceiver of the first plurality of terrestrial transceivers and the identity of each terrestrial transceiver of the second plurality of terrestrial transceivers are obtained from different sources.

8. The method of claim 1, wherein obtaining an identity of each terrestrial transceiver of the first plurality of terrestrial transceivers comprises receiving the identity of each terrestrial transceiver of the first plurality of terrestrial transceivers from a location server.

9. The method of claim 1, further comprising, for the one or more terrestrial transceivers, purging stored information indicative of the result of whether the attempt to measure the signals received from the one or more terrestrial transceivers was successful.

10. The method of claim 9 wherein the purging occurs after a threshold period of time has elapsed since the attempt to measure signals received from the one or more terrestrial transceivers.

11. The method of claim 9 wherein the purging occurs after receiving, from at least one location server, assistance data a threshold number of times.

12. The method of claim 1, further comprising, obtaining an identity of each terrestrial transceiver of a second plurality of terrestrial transceivers detected by the mobile device; and
sending, to a location server, an identity of at least one terrestrial transceiver of the second plurality of terrestrial transceivers not included in the first plurality of terrestrial transceivers.

13. A mobile device comprising:
a wireless communication interface;
a memory; and
a processing unit communicatively coupled with the wireless communication interface and the memory and configured to cause the mobile device to:
obtain information indicative of an estimated position of the mobile device;
send, via the wireless communication interface, the information indicative of an estimated position of the mobile device to a location server;
obtain an identity of each terrestrial transceiver of a first plurality of terrestrial transceivers, the first plurality of terrestrial transceivers selected based on the information indicative of the estimated position of the mobile device;
obtain a prioritization of one or more terrestrial transceivers from the first plurality of terrestrial transceivers based on:
the estimated position of the mobile device, and
a result of whether a prior attempt to measure signals received from the one or more terrestrial transceivers was unsuccessful; and
attempt to measure signals received from the one or more terrestrial transceivers in an order based on the prioritization.

14. (canceled)

15. The mobile device of claim 13, wherein the processing unit is further configured to cause the mobile device to store, in the memory, for each terrestrial transceiver of the one or more terrestrial transceivers, information associating a prior estimated location of the mobile device with an indication of the result of whether the prior attempt to measure the signals received from the one or more terrestrial transceivers was successful.

16. The mobile device of claim 13, wherein the processing unit is further configured to cause the mobile device to compute a position of the mobile device based on measurements of signals received from the one or more terrestrial transceivers.

17. The mobile device of claim 13, wherein the processing unit is further configured to cause the mobile device to, subsequent to obtaining the identity of each terrestrial transceiver of the first plurality of terrestrial transceivers, obtain an identity of each terrestrial transceiver of a second plurality of terrestrial transceivers, wherein the second plurality of terrestrial transceivers includes the one or more terrestrial transceivers.

18. The mobile device of claim 13, wherein the processing unit is further configured to cause the mobile device to obtain the identity of each terrestrial transceiver of the first plurality of terrestrial transceivers and the identity of each terrestrial transceiver of the second plurality of terrestrial transceivers from different sources.

19. An apparatus comprising:
means for obtaining information indicative of an estimated position of the apparatus;
means for sending the information indicative of an estimated position of the mobile device to a location server;
means for obtaining an identity of each terrestrial transceiver of a first plurality of terrestrial transceivers, the first plurality of terrestrial transceivers selected based on the information indicative of the estimated position of the mobile device;
means for obtaining a prioritization of one or more terrestrial transceivers from the first plurality of terrestrial transceivers based on:
the estimated position of the apparatus, and
a result of whether a prior attempt to measure signals received from of the one or more terrestrial transceivers was successful or unsuccessful; and
means for attempting to measure signals received from the one or more terrestrial transceivers in an order based on the prioritization.

20. (canceled)

21. The method of claim 1, wherein the prior unsuccessful attempt to measure the signal received from the at least one terrestrial transceiver comprises a prior attempt to measure a distance between the mobile device and the at least one terrestrial transceiver using the signal received from the at least one terrestrial transceiver.

22. The mobile device of claim 13, wherein the prior unsuccessful attempt to measure the signal received from the at least one terrestrial transceiver comprises a prior attempt to measure a distance between the mobile device and the at least one terrestrial transceiver using the signal received from the at least one terrestrial transceiver.

23. The apparatus of claim 19, wherein the prior unsuccessful attempt to measure the signal received from the at least one terrestrial transceiver comprises a prior attempt to measure a distance between the mobile device and the at least one terrestrial transceiver using the signal received from the at least one terrestrial transceiver.
